(19) United States
(12) Patent Application Publication
(10) Pub. No.: US 2002/0174426 A1
(43) Pub. Date: Nov. 21, 2002

(54) Method and apparatus for activating a media player based on user behavior

(75) Inventors: Srinivas Gutta, Buchanan, NY (US); Antonio J. Colmenarez, Peekskill, NY (US); Miroslav Trajkovic, Ossining, NY (US)

Correspondence Address: Michael E. Marion, Corporate Patent Counsel, U.S. Philips Corporation, 580 White Plains Road, Tarrytown, NY, 10591, US

(73) Assignee: Koninklijke Philips Electronics N.V

(21) Appl. No.: 09/858,209

(22) Filed: May 15, 2001

(51) Int. Cl. H04N 7/16; H04N 7/173

(52) U.S. Cl. 725/30; 725/92

(57) ABSTRACT

A media player controller is disclosed that monitors user activity and automatically activates a media player in response to predefined events. The disclosed media player controller includes one or more audio/visual mage capture devices focused on one or more users. The captured audio and video information is processed by the media player controller to identify one or more predefined events. A number of rules can be utilized to define various user events suggesting that the media player should be activated, such as when the user enters the room and demonstrates certain behavior. Each rule contains one or more conditions, and, optionally, a corresponding action-item that should be performed when the rule is satisfied. Upon detection of a predefined event, the corresponding action, if any, is performed by the media player controller.

### FIELD OF THE INVENTION

The present invention relates to methods and apparatus for controlling media players and other devices, and more particularly, to a method and apparatus for automatically activating a media player based on user activity.

### BACKGROUND OF THE INVENTION

The consumer marketplace offers a wide variety of electronic devices, such as televisions, stereo systems and personal computers, that provide an ever-growing number of features intended to increase the convenience and capabilities of these devices. Most entertainment devices, for example, have an associated remote control device that allows the user to adjust a number of the device settings remotely. For example, a user can activate a television or adjust the program channel, volume and other settings of the television using a remote control, in a well-known manner.

While remote controls and other additional features have greatly improved the convenience of such entertainment devices, they still require the affirmative action of the user to manipulate the remote control (or another input mechanism associated with the device) to turn on the device or indicate the manner in which the particular device settings should be adjusted. Thus, if the remote control is not readily available, or the user does not wish to move closer to the device itself, the user may still be unable to conveniently activate the device or adjust one or more settings in a desired manner.

It has been observed that there is often a predictable relationship between certain user activity and a corresponding manner in which the settings of an electronic device should be adjusted. For example, it may be observed that when a particular user sits in a particular chair at a certain time of day, the user also tends to turn on the television set using the remote control. There is currently no mechanism, however, that learns such ritualistic user activity and automatically activates the electronic device. A need therefore exists for a media player controller that monitors user activity and automatically activates a media player in response to predefined events or behavior. A further need exists for a media player controller that employs a rule-base to define user activities or events, as well as the corresponding response that should be implemented to activate the device.

### SUMMARY OF THE INVENTION

Generally, a method and apparatus are disclosed for monitoring user activity and automatically activating a media player in response to predefined events. The disclosed media player controller includes one or more audio/visual capture devices focused on one or more users. The obtained audio and video information is processed by the media player controller to identify one or more predefined events.

According to one aspect of the invention, a number of behavior rules define various user activities or events that suggest that the user would like to activate a media player. Each rule contains one or more conditions, and, optionally, a corresponding action-item that should be performed when the rule is satisfied to activate the media player. Upon detection of a predefined event, the corresponding action, if any, is performed by the media player controller.

A more complete understanding of the present invention, as well as further features and advantages of the present invention, will be obtained by reference to the following detailed description and drawings.

### BRIEF DESCRIPTION OF THE DRAWINGS

FIG. 1 illustrates a media player controller in accordance with the present invention;

FIG. 2 illustrates a sample table from the user profile of FIG. 1 in accordance with the present invention; and

FIG. 3 is a flow chart describing an exemplary user event monitoring process embodying principles of the present invention.

### DETAILED DESCRIPTION

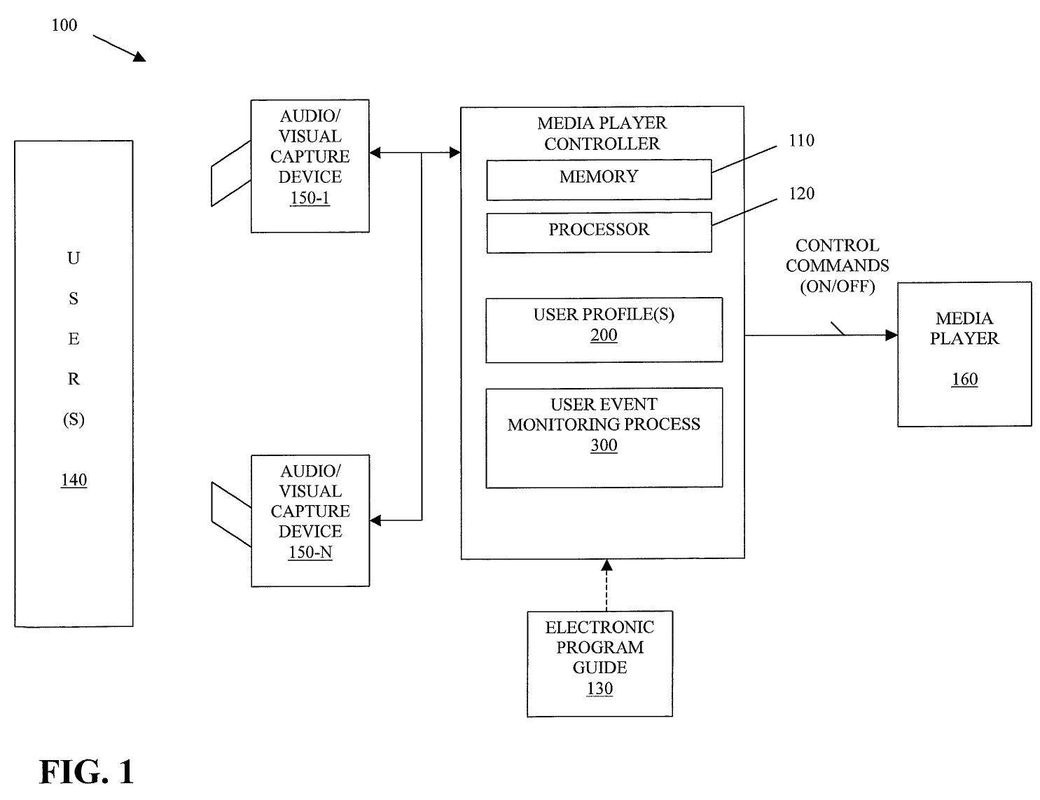

FIG. 1 illustrates a media player controller 100 in accordance with the present invention. As shown in FIG. 1, the media player controller 100 includes one or more audio/visual capture devices 150-1 through 150-N (hereinafter, collectively referred to as audio/visual capture devices 150) that are focused on one or more user(s) 140 of a media player 160.

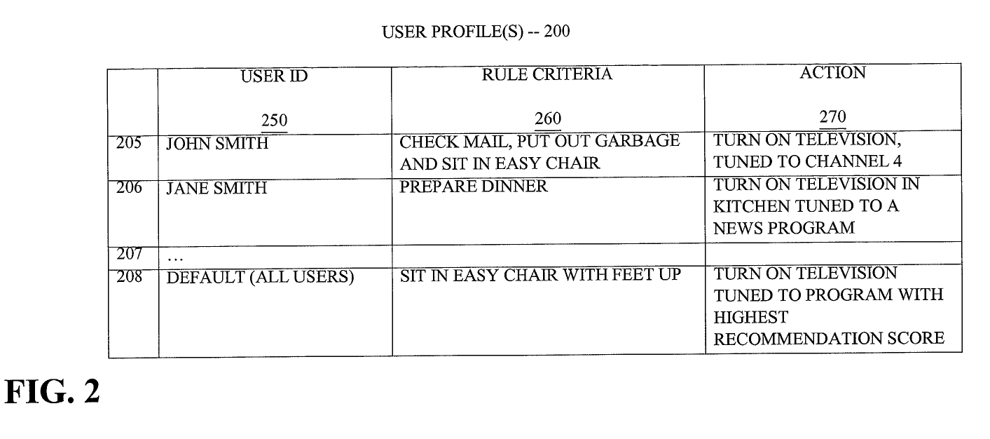

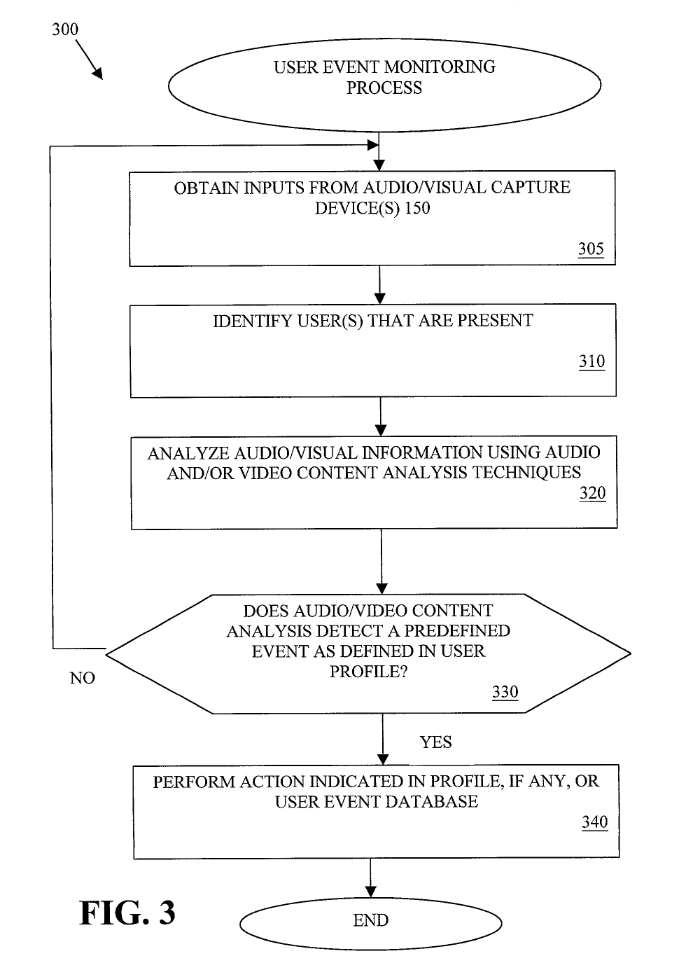

Each audio/visual capture device 150 may be embodied, for example, as a fixed or pan-tilt-zoom (PTZ) camera for capturing image or video information, or one or more microphones for capturing audio information (or both). The audio and video information generated by the audio/visual capture devices 150 are processed by the media player controller 100, in a manner discussed below in conjunction with FIG. 3, to identify one or more predefined user activities or events suggesting that the user would like to activate one or more media player(s) 160. In one implementation, the present invention employs a user profile 200, discussed further below in conjunction with FIG. 2, that identifies user behavior that should initiate the activation of the media player 160 in accordance with the present invention.

The user behavior defined in the profile 200 may be detected by the media player controller 100 in accordance with the present invention. As discussed further below, each behavior rule contains one or more criteria that must be satisfied in order for the rule to be triggered, and, optionally, a corresponding action-item that should be performed by the media player controller 100 to activate the media player 160 when the predefined criteria for initiating the behavior rule is satisfied.

At least one of the criteria for each rule is a condition detected in the audio or video information generated by the audio/visual capture devices 150 using audio or vision-based techniques, in accordance with the present invention. Upon detection of such predefined user behavior, the corresponding action, if any, is performed by the media player controller 100. Typically, the corresponding action is the issuance of a command to turn on (or off) the media player 160.

As discussed further below in conjunction with FIG. 2, the user behavior recorded in the user profile 200 may include one or more criteria that is dependent on external information, such as information from an optional electronic program guide 130. For example, the corresponding action-item that is performed by the media player controller 100 in response to a given user activity may be dependent on features of a program, as indicated in the electronic program guide 130.

As shown in FIG. 1, and discussed further below in conjunction with FIG. 3, the media player controller 100 also contains a user event monitoring process 300. Generally, the user event monitoring process 300 processes the audio information or images obtained by the audio/visual capture devices 150 and detects one or more predefined behavior actions that should trigger the activation of a media player 160.

The media player controller 100 may be embodied as any computing device, such as a personal computer or workstation, that contains a processor 120, such as a central processing unit (CPU), and memory 110, such as RAM and/or ROM. Alternatively, the media player controller 100 may be embodied as an application specific integrated circuit (ASIC) (not shown) that is included, for example, in a television, set-top terminal or another electronic device.

FIG. 2 illustrates an exemplary table of the user profile(s) 200 that records various behavioral rules for one or more users. Each rule in the user profile(s) 200 identifies the corresponding user(s) and includes predefined criteria specifying the conditions under which the rule should be initiated, and, optionally, a corresponding action item that should be triggered when the criteria associated with the rule is satisfied. Typically, the action item identifies the media player(s) 160 that should be activated when the rule is triggered.

As shown in FIG. 2, the user profile 200 is comprised of a plurality of records, such as records 205-208, each associated with a different behavioral rule. For each rule, the user profile 200 identifies the corresponding user(s) in field 250, the corresponding rule criteria for a given behavioral event in field 260 and the corresponding action, if any, in field 270.

For example, the user habits recorded in record 205 for the user, John Smith, indicates that the user generally turns on the television to a certain channel after checking the mail, putting out the garbage and sitting in a certain chair. Likewise, the user habits recorded in record 206 for the user, Jane Smith, indicates that the user likes to watch a news program while preparing dinner. Finally, the exemplary user habits recorded in record 208 for all users indicates that most users would like to turn on the television tuned to the highest ranking program when they sit in a certain seat with their feet up. Thus, the preferences in record 208 are dependent upon information from the electronic program guide 130.

Generally, the user behavior recorded in the user profile(s) 200 can be obtained explicitly, i.e., from survey responses, or implicitly, by monitoring how a given user responds to a given set of circumstances. Thereafter, a rule can be established that defines the given set of circumstances and the corresponding action item that should be performed.

FIG. 3 is a flow chart describing an exemplary user event monitoring process 300. The user event monitoring process 300 processes audio or video information (or both) obtained from the audio/visual capture devices 150 and detects one or more user events defined in the user profile 200. The exemplary user event monitoring process 300 is a general process illustrating the broad concepts of the present invention. As shown in FIG. 3, the user event monitoring process 300 initially obtains one or more inputs from the audio/visual capture devices 150 during step 305. Thereafter, the user event monitoring process 300 optionally identifies the user(s) that are present during step 310, for example, using a biometric evaluation of the audio or visual information obtained from the audio/visual capture device 150.

Thereafter, the audio/visual information is analyzed during step 320 using audio and/or video content analysis (VCA) techniques. For a detailed discussion of suitable audio content analysis techniques, see, for example, Silvia Pfeiffer et al., “Automatic Audio Content Analysis,” Proc. ACM Multimedia 96, 21-30, Boston, Mass. (Nov. 1996), incorporated by reference herein. For a detailed discussion of suitable VCA techniques, see, for example, Nathanael Rota and Monique Thonnat, “Video Sequence Interpretation for Visual Surveillance,” in Proc. of the 3d IEEE Int'l Workshop on Visual Surveillance, 59-67, Dublin, Ireland (Jul. 1, 2000), and Jonathan Owens and Andrew Hunter, “Application of the Self-Organizing Map to Trajectory Classification,' in Proc. of the 3d IEEE Int'l Workshop on Visual Surveillance, 77-83, Dublin, Ireland (Jul. 1, 2000), incorporated by reference herein. Generally, the audio content analysis and VCA techniques are employed to recognize various features in the signals obtained by the audio/visual capture devices 150.

A test is performed during step 330 to determine if the audio/video content analysis detects a predefined event, as defined in the user profile 300. If it is determined during step 330 that the audio/video content analysis does not detect a predefined event, then program control returns to step 310 to continue monitoring user activities in the manner discussed above.

If, however, it is determined during step 330 that the audio/video content analysis detects a predefined user event, then the event is processed during step 340 as indicated in field 270 of the user profile 200, if any, for the identified user. Program control then terminates (or returns to step 310 and continues monitoring user activities in the manner discussed above).

It is to be understood that the embodiments and variations shown and described herein are merely illustrative of the principles of this invention and that various modifications may be implemented by those skilled in the art without departing from the scope and spirit of the invention.

What is claimed is:

1. A method for activating a media player, comprising:
establishing at least one rule defining a predefined user activity, said rule including at least one condition and an action item to be performed to automatically activate said media player when said rule is satisfied;
analyzing at least one of audio and video information focused on a user to identify said condition; and
performing said action item if said rule is satisfied.

2. The method of claim 1, wherein said user activity suggests that said user would like to activate said media player.

3. The method of claim 2, wherein said user activity is ritualistic behavior and said action item is the issuance of a corresponding command to activate said media player.

4. The method of claim 2, wherein said user activity is a predefined gestural command and said action item is the issuance of a corresponding command to activate said media player.

5. The method of claim 1, wherein said rule includes one or more settings for said media player that should be established when said rule is satisfied.

6. A method for activating a media player, comprising:
analyzing at least one of audio and video information focused on a user to identify at least one predefined user behavior; and
activating said media player when said user activity is identified.

7. The method of claim 6, wherein said user behavior suggests that said user would like to activate said media player.

8. The method of claim 7, wherein said user behavior is ritualistic behavior and said action item is the issuance of a corresponding command to activate said media player.

9. The method of claim 7, wherein said user behavior is a predefined gestural command and said action item is the issuance of a corresponding command to activate said media player.

10. The method of claim 6, wherein said media player is activated with one or more predefined settings.

11. A system for activating a media player, comprising:
a memory for storing computer readable code; and
a processor operatively coupled to said memory, said processor configured to:
establish at least one rule defining a predefined user activity, said rule including at least one condition and an action item to be performed to automatically activate said media player when said rule is satisfied;
analyze at least one of audio and video information focused on a user to identify said condition; and
perform said action item if said rule is satisfied.

12. A system for activating a media player, comprising:
a memory for storing computer readable code; and
a processor operatively coupled to said memory, said processor configured to:
analyze at least one of audio and video information focused on a user to identify at least one predefined user behavior; and
activate said media player when said user activity is identified.

13. An article of manufacture for activating a media player, comprising:
a computer readable medium having computer readable code means embodied thereon, said computer readable program code means comprising:
a step to establish at least one rule defining a predefined user activity, said rule including at least one condition and an action item to be performed to automatically activate said media player when said rule is satisfied;
a step to analyze at least one of audio and video information focused on a user to identify said condition; and
a step to perform said action item if said rule is satisfied.

14. An article of manufacture for activating a media player, comprising:
a computer readable medium having computer readable code means embodied thereon, said computer readable program code means comprising:
a step to analyze at least one of audio and video information focused on a user to identify at least one predefined user behavior; and
a step to activate said media player when said user activity is identified.

15. A system for activating a media player, comprising:
means for establishing at least one rule defining a predefined user activity, said rule including at least one condition and an action item to be performed to automatically activate said media player when said rule is satisfied;
means for analyzing at least one of audio and video information focused on a user to identify said condition; and
means for performing said action item if said rule is satisfied.

16. A system for activating a media player, comprising:
means for analyzing at least one of audio and video information focused on a user to identify at least one predefined user behavior; and
means for activating said media player when said user activity is identified.
